(19) United States
(12) Patent Application Publication
(10) Pub. No.: US 2025/0062893 A1
(43) Pub. Date: Feb. 20, 2025

(54) BLOCKCHAIN-INTEGRATED AUTHENTICATION MECHANISMS FOR FIFTH GENERATION COMMUNICATION NETWORKS

(71) Applicant: Intel Corporation, Santa Clara, CA (US)

(72) Inventor: Abhijeet Kolekar, Leander, TX (US)

(21) Appl. No.: 18/935,069

(22) Filed: Nov. 1, 2024

Related U.S. Application Data
(60) Provisional application No. 63/595,678, filed on Nov. 2, 2023.

(51) Int. Cl. H04L 9/08; H04L 9/00; H04W 60/00

(52) U.S. Cl. CPC H04L 9/0825; H04L 9/50; H04W 60/00; H04L 2209/80

(57) ABSTRACT

Various embodiments herein provide techniques related to registering a user equipment (UE) with a wireless network based on a blockchain identity (BI) of the UE. In embodiments, the BI, or a derived key thereof, may be used to sign a cryptographic challenge provided by the network, wherein the challenge is based on the BI. Other embodiments may be described and/or claimed.

### CROSS REFERENCE TO RELATED APPLICATION

The present application claims priority to U.S. Provisional Patent Application No. 63/595,678, which was filed Nov. 2, 2023; the disclosure of which is hereby incorporated by reference.

### BACKGROUND

3GPP provides a security architecture that includes authentication procedures, security features, and security mechanisms for the fifth generation (5G) systems (5GS) and 5G core network (5GC), as well as security procedures that are performed within the 5GS including the 5GC and 5G New Radio (NR).

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example blockchain-based authentication procedure, in accordance with various embodiments.

FIG. 2 illustrates an example of a wireless network, in accordance with various embodiments.

FIG. 3 illustrates simplified examples of wireless devices, in accordance with various embodiments.

FIG. 4 illustrates a simplified example of an electronic device, in accordance with various embodiments.

FIG. 5 illustrates an alternative example of a wireless network, in accordance with various embodiments.

FIG. 6 illustrates an example procedure to be performed by a user equipment (UE), in accordance with various embodiments.

FIG. 7 illustrates an example procedure to be performed by an authentication server function (AUSF), in accordance with embodiments herein.

### DETAILED DESCRIPTION

### 1. Blockchain-Integrated Authentication Aspects

Legacy 5G authentication procedures, for example such as those that may be standardized in the third generation partnership project (3GPP) technical standard (TS) 33.501, may have been at least partially based on the assumption of the presence of a centralized core with a centralized authenticator and/or a centralized authentication server. However, there may be commercial, public safety, and mission-critical use cases wherein a user equipment (UE) is not able to get access to a centralized 5G core due to situations such as a) 5G base stations such as gNodeBs (gNBs) are not available, b) a 5G core is not available, or c) both 5G gNB and a 5G core are not available. In those situations, an alternative primary authentication technique may be desired so that a UE may still be able to perform primary authentication procedures.

As used herein, the term “primary authentication” may be used in a manner similar to that defined in 3GPP TS 33.501. Specifically, “primary authentication” may include or relate to an authentication and/or key agreement procedure that may enable mutual authentication between a UE and the network. Additionally or alternatively, primary authentication may provide keying material that can be used between a UE and the serving network in subsequent security procedures.

One use case example may include a situation wherein a disaster such as a hurricane, a flood, an earthquake, a wildfire, or war destroy 5G cellular infrastructure and/or power infrastructure. In this use case, first responders from different areas, including different countries, may gather at the scene to conduct rescue missions. They may need instant and on-the-fly, device-to-device communications (e.g., direct device connection as defined in 3GPP TS 22.261 between them using cellular devices such as 5G devices, sixth generation (6G) devices, and/or some other type of cellular device.

One deployment scenario for device-to-device (D2D) communications may include leveraging leverage 5G new radio (NR) sidelink technology to support out-of-coverage cases. This deployment scenario may be supported by architecture related to the 3GPP SA2 working group. To prevent third parties from listening or disrupting communications, it may be desirable to provide primary authentication.

In legacy networks, authentication may be supported in out-of-coverage cases with sidelink technology as follows: 1) UEs are authenticated while in-coverage with an infrastructure network (e.g., with a centralized 5GC), 2) security credentials are pre-provisioned to UEs, and then 3) UEs join the out-of-coverage network. However, during the natural disaster use case discussed above, elements 1) and 2) may not be possible because there may be no 5G RAN node or centralized 5GC available and/or there first responders from other locations may not have such authentication and/or pre-provisioning of security credentials.

It will be understood that the above is only one example of a possible use case. Other use cases for primary authentication may include or relate to commercial use cases, vehicle-to-everything (V2X), aircraft-to-everything (A2X), internet of things (IoT) sensors in coverage-challenged areas, a UE in a room with poor cellular radio frequency (RF) coverage, etc.

Table 1, below, provides an example of some service requirements of a 5G system. Such service requirements may be related to various sections of the 3GPP TS 22.261. It will be understood that, in some cases, at least one or more of the described service requirements may be related to other systems such as 6G systems or beyond.

TABLE 1
Examples of Service Requirements

| | Example location of |
|---|---|
| Requirement | TS 22.261 |
| The drivers include IoT, Virtual Reality (VR), industrial control, | § Introduction |
| ubiquitous on-demand coverage, as well as the opportunity to meet | |
| customized market needs. | |
| The 5G system shall enable users to obtain services from more than | § 6.18, 6.18.2 |
| one network simultaneously on an on-demand basis. | |
| The 5G system shall allow Personal IoT Network (PIN) Elements to | § 6.38.2.3 |
| communicate when there is no connectivity between a PIN Element | |
| with Gateway Capability and a 5G network. | |
| Based on user consent, operator policy and trusted 3rd party request, | § 6.40.2.2 |
| the 5G system shall support a means to authorize specific UEs to | |
| transmit data (e.g., artificial intelligence (AI)-machine learning (ML) | |
| model data for a specific application,) via direct device connection in | |
| a certain location and time. | |
| The 5G system shall support operator-controlled alternative | § 8.3 |
| authentication methods (i.e., alternative to Authentication and Key | |
| Agreement (AKA)) with different types of credentials for network | |
| access for IoT devices in isolated deployment scenarios (e.g., for | |
| industrial automation). The 5G system shall support a suitable | |
| framework (e.g., extensible authentication protocol (EAP)) allowing | |
| alternative (e.g., to AKA) authentication methods with non-3GPP | |
| identities and credentials to be used for UE network access | |
| authentication in non-public networks. | |
| For a private network using 5G technology, the 5G system shall | § 8.5 |
| support network access using identities, credentials, and | |
| authentication methods provided and managed by a third-party and | |
| supported by 3GPP. | |

Embodiments herein may include or relate to blockchain-based authentication to 3GPP primary authentication. In some examples, a blockchain-based authentication procedure may be as follows: (1) a UE (e.g., UE 202) registers its decentralized identity and public key with the blockchain. A Trusted Attestation Entity (TA), such as a service provider or original equipment manufacturer (OEM), adds a digital attestation for the UE on the blockchain; (2) when the UE wants to connect, a Network Function (NF), which can represent 5G network elements, presents a challenge to the UE. The UE signs this challenge with its private key; (3) the smart contract on the blockchain verifies the signature using the UE's public key and checks if there's a valid attestation for the UE; and (4) The NF acknowledges the authentication and establishes a secure session with the UE if everything is verified.

As used herein, the term “blockchain” may refer to a public ledger of authentication data that is shared between a UE and a core network such as the 5GC, a sixth generation (6G) core network, and/or some other type of core network. In embodiments, authentication data of different subscribers may be linked in a chain of the public ledger.

The blockchain-based authentication aspects discussed herein may enable decentralization, such as a decentralized 5GC. Using the aspects discussed herein, access to a centralized 5GC core may not be required for authentication, and so the authentication discussed herein may be suitable for scenarios where the central core is inaccessible. The blockchain-based authentication aspects discussed herein may also provide transparency and immutability due to related authentication records being transparent and immutable, ensuring high trust. The blockchain-based authentication aspects discussed herein may also provide interoperability between different devices, service providers, and even network technologies in situations wherein the devices/providers/technologies adhere to the blockchain protocol.

More specifically, in embodiments, the present disclosure may integrate blockchain technology into 5G authentication mechanisms. Doing so may leverage the strengths of cryptographic signatures and distributed ledger technology to enhance security and transparency in 5G communication networks.

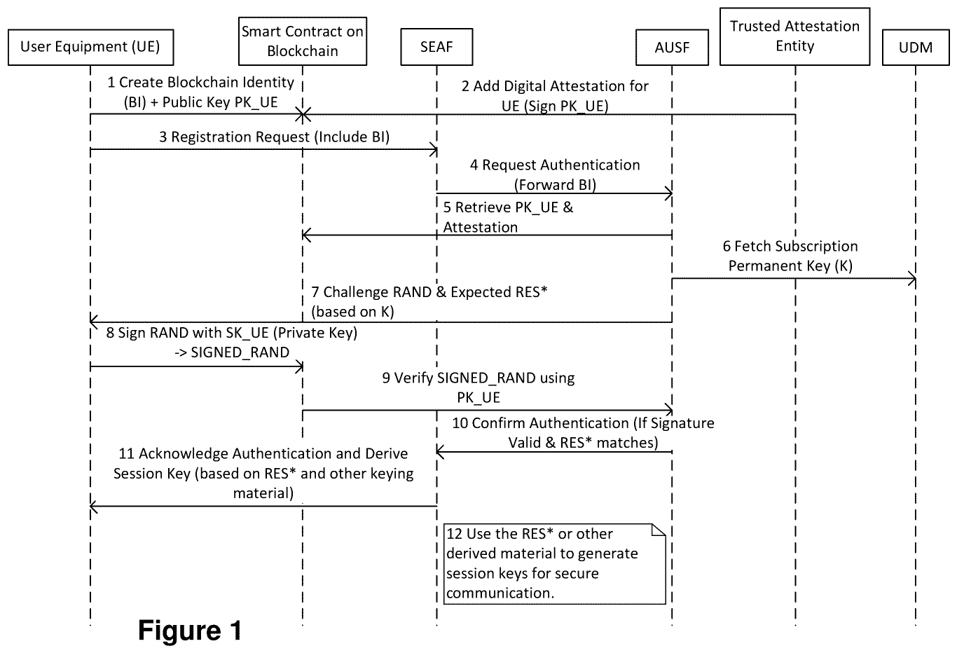

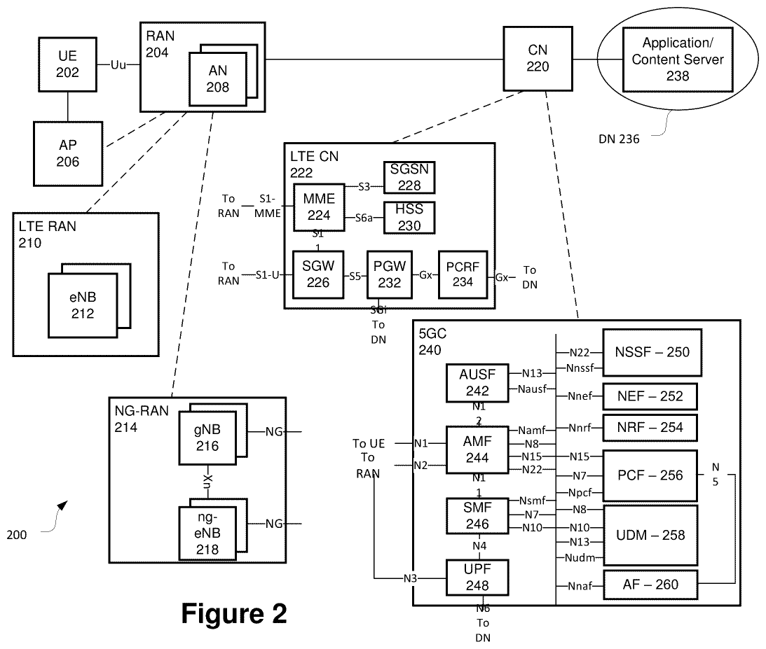

FIG. 1 shows an example blockchain-based authentication procedure. The network nodes, such as the UE, Security Anchor Function (SEAF), Authentication Server Function (AUSF), and unified data management (UDM) function may be the same or similar to those discussed infra with respect to FIGS. 2-5, and/or some other Figure herein. In one example embodiments, the procedure of FIG. 1 may operate as follows:
1. Initialization of Blockchain Identity: A UE (e.g., UE 202), initializes its presence on a blockchain by creating a unique Blockchain Identity (BI). Accompanying this BI, the UE generates and stores a cryptographic public key, denoted as PK_UE, on the blockchain.
2. Attestation of UE's Identity: A Trusted Attestation Entity (TA), which may be or may include a 5G service provider or operator, or an electronic device thereof, facilitates the process by digitally attesting or verifying the UE's public key. The TA signs the PK_UE to provide a layer of authenticity and trustworthiness to the UE's blockchain-based identity.
3. Service Request Initiation: Upon requiring network services, the UE initiates a service request (Registration Request) to the SEAF and provides its Blockchain Identity (BI) as a form of identification.
4. Authentication Request: In response, the SEAF forwards this service request, along with the BI, to the AUSF (e.g., AUSF 242) to initiate the authentication process.
5. Retrieval of UE Cryptographic Details: The AUSF queries the blockchain, utilizing the provided BI, to fetch the authenticated public key (PK_UE) and its associated digital attestation.
6. Fetching Subscription Permanent Key: Concurrently, the AUSF communicates with the UDM (e.g., UDM 258) to retrieve the Subscription Permanent Key (K) associated with the requesting UE.
7. Challenge Generation and Dispatch: Based on the obtained K, the AUSF crafts a cryptographic challenge, indicated in FIG. 1 as “RAND,” and determines an expected response, indicated in FIG. 1 as “RES*.”
8. This challenge-response pair is dispatched to the UE for validation.
9. Signature Generation and Verification: The UE, using its private key (SK_UE), signs the received RAND, producing a SIGNED_RAND.
10. This signed data is subsequently submitted to the blockchain's smart contract for verification against the earlier stored PK_UE.
11. Authentication Confirmation: If the blockchain-verified signature aligns and the derived RES* corresponds with the AUSF's expectation, the AUSF acknowledges the authentication's success to the SEAF.
12. Session Key Derivation: Post successful authentication, the SEAF communicates the outcome to the UE. Both entities cooperatively derive a session key predicated upon the RES* and additional keying materials. This session key ensures secure and encrypted communication for the session's duration.

FIG. 2 illustrates a network 200 in accordance with various embodiments. The network 200 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 200 may include a UE 202 (which may be similar to the UE depicted in FIG. 1), which may include any mobile or non-mobile computing device designed to communicate with a RAN 204 via an over-the-air connection. The UE 202 may be communicatively coupled with the RAN 204 by a Uu interface. The UE 202 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 200 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 202 may additionally communicate with an AP 206 via an over-the-air connection. The AP 206 may manage a WLAN connection, which may serve to offload some/all network traffic from the RAN 204. The connection between the UE 202 and the AP 206 may be consistent with any IEEE 802.11 protocol, wherein the AP 206 could be a wireless fidelity (Wi-Fi®) router. In some embodiments, the UE 202, RAN 204, and AP 206 may utilize cellular-WLAN aggregation (for example, LWA/LWIP). Cellular-WLAN aggregation may involve the UE 202 being configured by the RAN 204 to utilize both cellular radio resources and WLAN resources.

The RAN 204 may include one or more access nodes, for example, AN 208. AN 208 may terminate air-interface protocols for the UE 202 by providing access stratum protocols including RRC, PDCP, RLC, MAC, and LI protocols. In this manner, the AN 208 may enable data/voice connectivity between CN 220 and the UE 202. In some embodiments, the AN 208 may be implemented in a discrete device or as one or more software entities running on server computers as part of, for example, a virtual network, which may be referred to as a CRAN or virtual baseband unit pool. The AN 208 be referred to as a BS, gNB, RAN node, cNB, ng-eNB, NodeB, RSU, TRxP, TRP, etc. The AN 208 may be a macrocell base station or a low power base station for providing femtocells, picocells or other like cells having smaller coverage areas, smaller user capacity, or higher bandwidth compared to macrocells.

In embodiments in which the RAN 204 includes a plurality of ANs, they may be coupled with one another via an X2 interface (if the RAN 204 is an LTE RAN) or an Xn interface (if the RAN 204 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 204 may each manage one or more cells, cell groups, component carriers, etc. to provide the UE 202 with an air interface for network access. The UE 202 may be simultaneously connected with a plurality of cells provided by the same or different ANs of the RAN 204. For example, the UE 202 and RAN 204 may use carrier aggregation to allow the UE 202 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-cNB, etc.

The RAN 204 may provide the air interface over a licensed spectrum or an unlicensed spectrum. To operate in the unlicensed spectrum, the nodes may use LAA, cLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 202 or AN 208 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 204 may be an LTE RAN 210 with eNBs, for example, cNB 212. The LTE RAN 210 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 204 may be an NG-RAN 214 with gNBs, for example, gNB 216, or ng-eNBs, for example, ng-eNB 218. The gNB 216 may connect with 5G-enabled UEs using a 5G NR interface. The gNB 216 may connect with a 5G core through an NG interface, which may include an N2 interface or an N3 interface. The ng-eNB 218 may also connect with the 5G core through an NG interface, but may connect with a UE via an LTE air interface. The gNB 216 and the ng-cNB 218 may connect with each other over an Xn interface.

In some embodiments, the NG interface may be split into two parts, an NG user plane (NG-U) interface, which carries traffic data between the nodes of the NG-RAN 214 and a UPF 248 (e.g., N3 interface), and an NG control plane (NG-C) interface, which is a signaling interface between the nodes of the NG-RAN214 and an AMF 244 (e.g., N2 interface).

The NG-RAN 214 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FRI bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 202 can be configured with multiple BWPs where each BWP configuration has a different SCS. When a BWP change is indicated to the UE 202, the SCS of the transmission is changed as well. Another use case example of BWP is related to power saving. In particular, multiple BWPs can be configured for the UE 202 with different amount of frequency resources (for example, PRBs) to support data transmission under different traffic loading scenarios. A BWP containing a smaller number of PRBs can be used for data transmission with small traffic load while allowing power saving at the UE 202 and in some cases at the gNB 216. A BWP containing a larger number of PRBs can be used for scenarios with higher traffic load.

The RAN 204 is communicatively coupled to CN 220 that includes network elements to provide various functions to support data and telecommunications services to customers/subscribers (for example, users of UE 202). The components of the CN 220 may be implemented in one physical node or separate physical nodes. In some embodiments, NFV may be utilized to virtualize any or all of the functions provided by the network elements of the CN 220 onto physical compute/storage resources in servers, switches, etc. A logical instantiation of the CN 220 may be referred to as a network slice, and a logical instantiation of a portion of the CN 220 may be referred to as a network sub-slice.

In some embodiments, the CN 220 may be an LTE CN 222, which may also be referred to as an EPC. The LTE CN 222 may include MME 224, SGW 226, SGSN 228, HSS 230, PGW 232, and PCRF 234 coupled with one another over interfaces (or “reference points”) as shown. Functions of the elements of the LTE CN 222 may be briefly introduced as follows.

The MME 224 may implement mobility management functions to track a current location of the UE 202 to facilitate paging, bearer activation/deactivation, handovers, gateway selection, authentication, etc.

The SGW 226 may terminate an SI interface toward the RAN and route data packets between the RAN and the LTE CN 222. The SGW 226 may be a local mobility anchor point for inter-RAN node handovers and also may provide an anchor for inter-3GPP mobility. Other responsibilities may include lawful intercept, charging, and some policy enforcement.

The SGSN 228 may track a location of the UE 202 and perform security functions and access control. In addition, the SGSN 228 may perform inter-EPC node signaling for mobility between different RAT networks; PDN and S-GW selection as specified by MME 224; MME selection for handovers; etc. The S3 reference point between the MME 224 and the SGSN 228 may enable user and bearer information exchange for inter-3GPP access network mobility in idle/active states.

The HSS 230 may include a database for network users, including subscription-related information to support the network entities' handling of communication sessions. The HSS 230 can provide support for routing/roaming, authentication, authorization, naming/addressing resolution, location dependencies, etc. An S6a reference point between the HSS 230 and the MME 224 may enable transfer of subscription and authentication data for authenticating/authorizing user access to the LTE CN 220.

The PGW 232 may terminate an SGi interface toward a data network (DN) 236 that may include an application/content server 238. The PGW 232 may route data packets between the LTE CN 222 and the data network 236. The PGW 232 may be coupled with the SGW 226 by an S5 reference point to facilitate user plane tunneling and tunnel management. The PGW 232 may further include a node for policy enforcement and charging data collection (for example, PCEF). Additionally, the SGi reference point between the PGW 232 and the data network 2 36 may be an operator external public, a private PDN, or an intra-operator packet data network, for example, for provision of IMS services. The PGW 232 may be coupled with a PCRF 234 via a Gx reference point.

The PCRF 234 is the policy and charging control element of the LTE CN 222. The PCRF 234 may be communicatively coupled to the app/content server 238 to determine appropriate QoS and charging parameters for service flows. The PCRF 232 may provision associated rules into a PCEF (via Gx reference point) with appropriate TFT and QCI.

In some embodiments, the CN 220 may be a 5GC 240. The 5GC 240 may include an AUSF 242, AMF 244, SMF 246, UPF 248, NSSF 250, NEF 252, NRF 254, PCF 256, UDM 258, and AF 260 coupled with one another over interfaces (or “reference points”) as shown. Functions of the elements of the 5GC 240 may be briefly introduced as follows.

The AUSF 242 may store data for authentication of UE 202 and handle authentication-related functionality. The AUSF 242 may facilitate a common authentication framework for various access types. In addition to communicating with other elements of the 5GC 240 over reference points as shown, the AUSF 242 may exhibit an Nausf service-based interface.

The AMF 244 may allow other functions of the 5GC 240 to communicate with the UE 202 and the RAN 204 and to subscribe to notifications about mobility events with respect to the UE 202. The AMF 244 may be responsible for registration management (for example, for registering UE 202), connection management, reachability management, mobility management, lawful interception of AMF-related events, and access authentication and authorization. The AMF 244 may provide transport for SM messages between the UE 202 and the SMF 246, and act as a transparent proxy for routing SM messages. AMF 244 may also provide transport for SMS messages between UE 202 and an SMSF. AMF 244 may interact with the AUSF 242 and the UE 202 to perform various security anchor and context management functions. Furthermore, AMF 244 may be a termination point of a RAN CP interface, which may include or be an N2 reference point between the RAN 204 and the AMF 244; and the AMF 244 may be a termination point of NAS (N1) signaling, and perform NAS ciphering and integrity protection. AMF 244 may also support NAS signaling with the UE 202 over an N3 IWF interface.

The SMF 246 may be responsible for SM (for example, session establishment, tunnel management between UPF 248 and AN 208); UE IP address allocation and management (including optional authorization); selection and control of UP function; configuring traffic steering at UPF 248 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 244 over N2 to AN 208; and determining SSC mode of a session. SM may refer to management of a PDU session, and a PDU session or “session” may refer to a PDU connectivity service that provides or enables the exchange of PDUs between the UE 202 and the data network 236.

The UPF 248 may act as an anchor point for intra-RAT and inter-RAT mobility, an external PDU session point of interconnect to data network 236, and a branching point to support multi-homed PDU session. The UPF 248 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 248 may include an uplink classifier to support routing traffic flows to a data network.

The NSSF 250 may select a set of network slice instances serving the UE 202. The NSSF 250 may also determine allowed NSSAI and the mapping to the subscribed S-NSSAIs, if needed. The NSSF 250 may also determine the AMF set to be used to serve the UE 202, or a list of candidate AMFs based on a suitable configuration and possibly by querying the NRF 254. The selection of a set of network slice instances for the UE 202 may be triggered by the AMF 244 with which the UE 202 is registered by interacting with the NSSF 250, which may lead to a change of AMF. The NSSF 250 may interact with the AMF 244 via an N22 reference point; and may communicate with another NSSF in a visited network via an N31 reference point (not shown). Additionally, the NSSF 250 may exhibit an Nnssf service-based interface.

The NEF 252 may securely expose services and capabilities provided by 3GPP network functions for third party, internal exposure/re-exposure, AFs (e.g., AF 260), edge computing or fog computing systems, etc. In such embodiments, the NEF 252 may authenticate, authorize, or throttle the AFs. NEF 252 may also translate information exchanged with the AF 260 and information exchanged with internal network functions. For example, the NEF 252 may translate between an AF-Service-Identifier and an internal 5GC information. NEF 252 may also receive information from other NFs based on exposed capabilities of other NFs. This information may be stored at the NEF 252 as structured data, or at a data storage NF using standardized interfaces. The stored information can then be re-exposed by the NEF 252 to other NFs and AFs, or used for other purposes such as analytics. Additionally, the NEF 252 may exhibit an Nnef service-based interface.

The NRF 254 may support service discovery functions, receive NF discovery requests from NF instances, and provide the information of the discovered NF instances to the NF instances. NRF 254 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 254 may exhibit the Nnrf service-based interface.

The PCF 256 may provide policy rules to control plane functions to enforce them, and may also support unified policy framework to govern network behavior. The PCF 256 may also implement a front end to access subscription information relevant for policy decisions in a UDR of the UDM 258. In addition to communicating with functions over reference points as shown, the PCF 256 exhibit an Npcf service-based interface.

The UDM 258 may handle subscription-related information to support the network entities' handling of communication sessions, and may store subscription data of UE 202. For example, subscription data may be communicated via an N8 reference point between the UDM 258 and the AMF 244. The UDM 258 may include two parts, an application front end and a UDR. The UDR may store subscription data and policy data for the UDM 258 and the PCF 256, and/or structured data for exposure and application data (including PFDs for application detection, application request information for multiple UEs 202) for the NEF 252. The Nudr service-based interface may be exhibited by the UDR 221 to allow the UDM 258, PCF 256, and NEF 252 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 258 may exhibit the Nudm service-based interface.

The AF 260 may provide application influence on traffic routing, provide access to NEF, and interact with the policy framework for policy control.

In some embodiments, the 5GC 240 may enable edge computing by selecting operator/3rd party services to be geographically close to a point that the UE 202 is attached to the network. This may reduce latency and load on the network. To provide edge-computing implementations, the 5GC 240 may select a UPF 248 close to the UE 202 and execute traffic steering from the UPF 248 to data network 236 via the N6 interface. This may be based on the UE subscription data, UE location, and information provided by the AF 260. In this way, the AF 260 may influence UPF (re) selection and traffic routing. Based on operator deployment, when AF 260 is considered to be a trusted entity, the network operator may permit AF 260 to interact directly with relevant NFs. Additionally, the AF 260 may exhibit an Naf service-based interface.

The data network 236 may represent various network operator services, Internet access, or third party services that may be provided by one or more servers including, for example, application/content server 238.

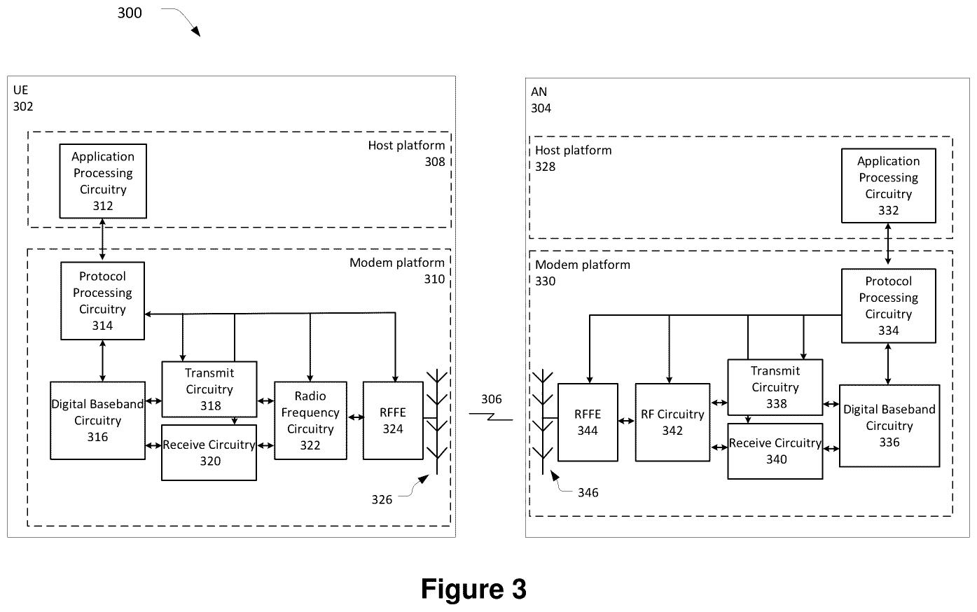

FIG. 3 schematically illustrates a wireless network 300 in accordance with various embodiments. The wireless network 300 may include a UE 302 in wireless communication with an AN 304. The UE 302 and AN 304 may be similar to, and substantially interchangeable with, like-named components described elsewhere herein.

The UE 302 may be communicatively coupled with the AN 304 via connection 306. The connection 306 is illustrated as an air interface to enable communicative coupling, and can be consistent with cellular communications protocols such as an LTE protocol or a 5G NR protocol operating at mmWave or sub-6 GHZ frequencies.

The UE 302 may include a host platform 308 coupled with a modem platform 310. The host platform 308 may include application processing circuitry 312, which may be coupled with protocol processing circuitry 314 of the modem platform 310. The application processing circuitry 312 may run various applications for the UE 302 that source/sink application data. The application processing circuitry 312 may further implement one or more layer operations to transmit/receive application data to/from a data network. These layer operations may include transport (for example UDP) and Internet (for example, IP) operations

The protocol processing circuitry 314 may implement one or more of layer operations to facilitate transmission or reception of data over the connection 306. The layer operations implemented by the protocol processing circuitry 314 may include, for example, MAC, RLC, PDCP, RRC and NAS operations.

The modem platform 310 may further include digital baseband circuitry 316 that may implement one or more layer operations that are “below” layer operations performed by the protocol processing circuitry 314 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 310 may further include transmit circuitry 318, receive circuitry 320, RF circuitry 322, and RF front end (RFFE) 324, which may include or connect to one or more antenna panels 326. Briefly, the transmit circuitry 318 may include a digital-to-analog converter, mixer, intermediate frequency (IF) components, etc.; the receive circuitry 320 may include an analog-to-digital converter, mixer, IF components, etc.; the RF circuitry 322 may include a low-noise amplifier, a power amplifier, power tracking components, etc.; RFFE 324 may include filters (for example, surface/bulk acoustic wave filters), switches, antenna tuners, beamforming components (for example, phase-array antenna components), etc. The selection and arrangement of the components of the transmit circuitry 318, receive circuitry 320, RF circuitry 322, RFFE 324, and antenna panels 326 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 314 may include one or more instances of control circuitry (not shown) to provide control functions for the transmit/receive components.

A UE reception may be established by and via the antenna panels 326, RFFE 324, RF circuitry 322, receive circuitry 320, digital baseband circuitry 316, and protocol processing circuitry 314. In some embodiments, the antenna panels 326 may receive a transmission from the AN 304 by receive-beamforming signals received by a plurality of antennas/antenna elements of the one or more antenna panels 326.

A UE transmission may be established by and via the protocol processing circuitry 314, digital baseband circuitry 316, transmit circuitry 318, RF circuitry 322, RFFE 324, and antenna panels 326. In some embodiments, the transmit components of the UE 304 may apply a spatial filter to the data to be transmitted to form a transmit beam emitted by the antenna elements of the antenna panels 326.

Similar to the UE 302, the AN 304 may include a host platform 328 coupled with a modem platform 330. The host platform 328 may include application processing circuitry 332 coupled with protocol processing circuitry 334 of the modem platform 330. The modem platform may further include digital baseband circuitry 336, transmit circuitry 338, receive circuitry 340, RF circuitry 342, RFFE circuitry 344, and antenna panels 346. The components of the AN 304 may be similar to and substantially interchangeable with like-named components of the UE 302. In addition to performing data transmission/reception as described above, the components of the AN 308 may perform various logical functions that include, for example, RNC functions such as radio bearer management, uplink and downlink dynamic radio resource management, and data packet scheduling.

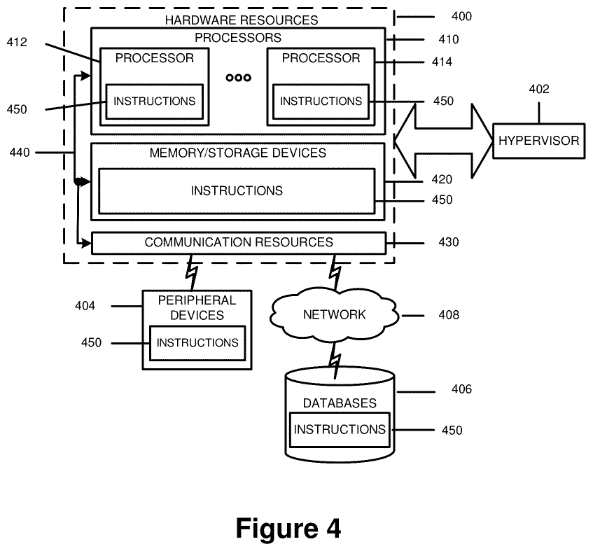

FIG. 4 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 4 shows a diagrammatic representation of hardware resources 400 including one or more processors (or processor cores) 410, one or more memory/storage devices 420, and one or more communication resources 430, each of which may be communicatively coupled via a bus 440 or other interface circuitry. For embodiments where node virtualization (e.g., NFV) is utilized, a hypervisor 402 may be executed to provide an execution environment for one or more network slices/sub-slices to utilize the hardware resources 400.

The processors 410 may include, for example, a processor 412 and a processor 414. The processors 410 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 420 may include main memory, disk storage, or any suitable combination thereof. The memory/storage devices 420 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 430 may include interconnection or network interface controllers, components, or other suitable devices to communicate with one or more peripheral devices 404 or one or more databases 406 or other network elements via a network 408. For example, the communication resources 430 may include wired communication components (e.g., for coupling via USB, Ethernet, etc.), cellular communication components, NFC components, Bluetooth® (or Bluetooth® Low Energy) components, Wi-Fi® components, and other communication components.

Instructions 450 may comprise software, a program, an application, an applet, an app, or other executable code for causing at least any of the processors 410 to perform any one or more of the methodologies discussed herein. The instructions 450 may reside, completely or partially, within at least one of the processors 410 (e.g., within the processor's cache memory), the memory/storage devices 420, or any suitable combination thereof. Furthermore, any portion of the instructions 450 may be transferred to the hardware resources 400 from any combination of the peripheral devices 404 or the databases 406. Accordingly, the memory of processors 410, the memory/storage devices 420, the peripheral devices 404, and the databases 406 are examples of computer-readable and machine-readable media.

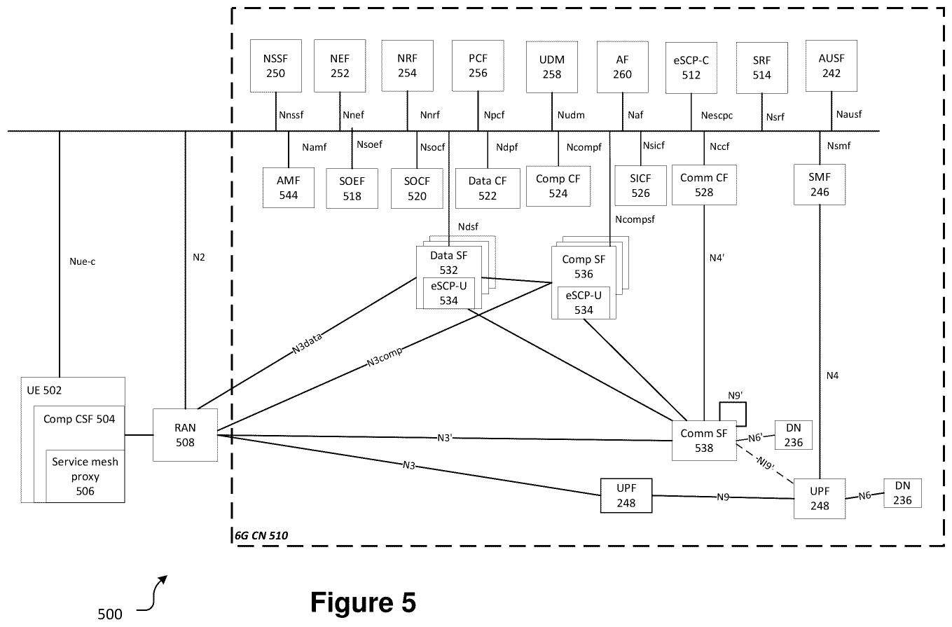

FIG. 5 illustrates a network 500 in accordance with various embodiments. The network 500 may operate in a matter consistent with 3GPP technical specifications or technical reports for 6G systems. In some embodiments, the network 500 may operate concurrently with network 200. For example, in some embodiments, the network 500 may share one or more frequency or bandwidth resources with network 200. As one specific example, a UE (e.g., UE 502) may be configured to operate in both network 500 and network 200. Such configuration may be based on a UE including circuitry configured for communication with frequency and bandwidth resources of both networks 200 and 500. In general, several elements of network 500 may share one or more characteristics with elements of network 200. For the sake of brevity and clarity, such elements may not be repeated in the description of network 500.

The network 500 may include a UE 502, which may include any mobile or non-mobile computing device designed to communicate with a RAN 508 via an over-the-air connection. The UE 502 may be similar to, for example, UE 202. The UE 502 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not specifically shown in FIG. 5, in some embodiments the network 500 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not specifically shown in FIG. 5, the UE 502 may be communicatively coupled with an AP such as AP 206 as described with respect to FIG. 2. Additionally, although not specifically shown in FIG. 5, in some embodiments the RAN 508 may include one or more ANss such as AN 208 as described with respect to FIG. 2. The RAN 508 and/or the AN of the RAN 508 may be referred to as a base station (BS), a RAN node, or using some other term or name.

The UE 502 and the RAN 508 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mm Wave” frequency ranges.

The RAN 508 may allow for communication between the UE 502 and a 6G core network (CN) 510. Specifically, the RAN 508 may facilitate the transmission and reception of data between the UE 502 and the 6G CN 510. The 6G CN 510 may include various functions such as NSSF 250, NEF 252, NRF 254, PCF 256, UDM 258, AF 260, SMF 246, and AUSF 242. The 6G CN 510 may additional include UPF 248 and DN 236 as shown in FIG. 5.

Additionally, the RAN 508 may include various additional functions that are in addition to, or alternative to, functions of a legacy cellular network such as a 4G or 5G network. Two such functions may include a Compute Control Function (Comp CF) 524 and a Compute Service Function (Comp SF) 536. The Comp CF 524 and the Comp SF 536 may be parts or functions of the Computing Service Plane. Comp CF 524 may be a control plane function that provides functionalities such as management of the Comp SF 536, computing task context generation and management (e.g., create, read, modify, delete), interaction with the underlying computing infrastructure for computing resource management, etc., Comp SF 536 may be a user plane function that serves as the gateway to interface computing service users (such as UE 502) and computing nodes behind a Comp SF instance. Some functionalities of the Comp SF 536 may include: parse computing service data received from users to compute tasks executable by computing nodes; hold service mesh ingress gateway or service API gateway; service and charging policies enforcement; performance monitoring and telemetry collection, etc. In some embodiments, a Comp SF 536 instance may serve as the user plane gateway for a cluster of computing nodes. A Comp CF 524 instance may control one or more Comp SF 536 instances.

Two other such functions may include a Communication Control Function (Comm CF) 528 and a Communication Service Function (Comm SF) 538, which may be parts of the Communication Service Plane. The Comm CF 528 may be the control plane function for managing the Comm SF 538, communication sessions creation/configuration/releasing, and managing communication session context. The Comm SF 538 may be a user plane function for data transport. Comm CF 528 and Comm SF 538 may be considered as upgrades of SMF 246 and UPF 248, which were described with respect to a 5G system in FIG. 2. The upgrades provided by the Comm CF 528 and the Comm SF 538 may enable service-aware transport. For legacy (e.g., 4G or 5G) data transport, SMF 246 and UPF 248 may still be used.

Two other such functions may include a Data Control Function (Data CF) 522 and Data Service Function (Data SF) 532 may be parts of the Data Service Plane. Data CF 522 may be a control plane function and provides functionalities such as Data SF 532 management, Data service creation/configuration/releasing, Data service context management, etc. Data SF 532 may be a user plane function and serve as the gateway between data service users (such as UE 502 and the various functions of the 6G CN 510) and data service endpoints behind the gateway. Specific functionalities may include include: parse data service user data and forward to corresponding data service endpoints, generate charging data, report data service status.

Another such function may be the Service Orchestration and Chaining Function (SOCF) 520, which may discover, orchestrate and chain up communication/computing/data services provided by functions in the network. Upon receiving service requests from users, SOCF 520 may interact with one or more of Comp CF 524, Comm CF 528, and Data CF 522 to identify Comp SF 536, Comm SF 538, and Data SF 532 instances, configure service resources, and generate the service chain, which could contain multiple Comp SF 536, Comm SF 538, and Data SF 532 instances and their associated computing endpoints. Workload processing and data movement may then be conducted within the generated service chain. The SOCF 520 may also responsible for maintaining, updating, and releasing a created service chain.

Another such function may be the service registration function (SRF) 514, which may act as a registry for system services provided in the user plane such as services provided by service endpoints behind Comp SF 536 and Data SF 532 gateways and services provided by the UE 502. The SRF 514 may be considered a counterpart of NRF 254, which may act as the registry for network functions.

Other such functions may include an evolved service communication proxy (eSCP) and service infrastructure control function (SICF) 526, which may provide service communication infrastructure for control plane services and user plane services. The eSCP may be related to the service communication proxy (SCP) of 5G with user plane service communication proxy capabilities being added. The eSCP is therefore expressed in two parts: eCSP-C 512 and eSCP-U 534, for control plane service communication proxy and user plane service communication proxy, respectively. The SICF 526 may control and configure eCSP instances in terms of service traffic routing policies, access rules, load balancing configurations, performance monitoring, etc.

Another such function is the AMF 544. The AMF 544 may be similar to 244, but with additional functionality. Specifically, the AMF 544 may include potential functional repartition, such as move the message forwarding functionality from the AMF 544 to the RAN 508.

Another such function is the service orchestration exposure function (SOEF) 518. The SOEF may be configured to expose service orchestration and chaining services to external users such as applications.

The UE 502 may include an additional function that is referred to as a computing client service function (comp CSF) 504. The comp CSF 504 may have both the control plane functionalities and user plane functionalities, and may interact with corresponding network side functions such as SOCF 520, Comp CF 524, Comp SF 536, Data CF 522, and/or Data SF 532 for service discovery, request/response, compute task workload exchange, etc. The Comp CSF 504 may also work with network side functions to decide on whether a computing task should be run on the UE 502, the RAN 508, and/or an element of the 6G CN 510.

The UE 502 and/or the Comp CSF 504 may include a service mesh proxy 506. The service mesh proxy 506 may act as a proxy for service-to-service communication in the user plane. Capabilities of the service mesh proxy 506 may include one or more of addressing, security, load balancing, etc.

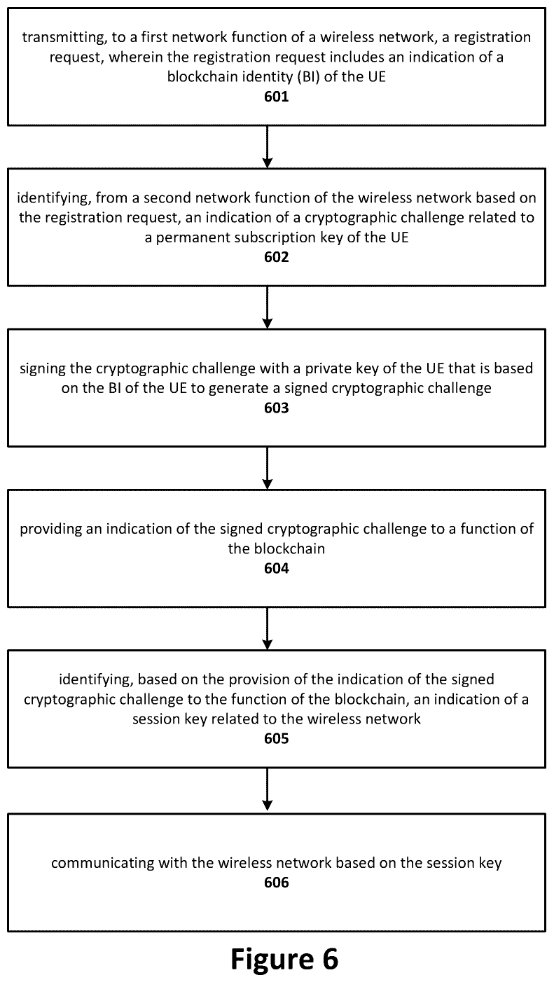

In some embodiments, the electronic device(s), network(s), system(s), chip(s) or component(s), or portions or implementations thereof, of FIGS. 1-5, or some other figure herein, may be configured to perform one or more processes, techniques, or methods as described herein, or portions thereof. One such process is depicted in FIG. 6. The process of FIG. 6 may include or relate to a method to be performed by a user equipment (UE), one or more elements of a UE, and/or one or more electronic devices that include and/or implement a UE. The process may include transmitting, at 601 to a first network function of a wireless network, a registration request, wherein the registration request includes an indication of a blockchain identity (BI) of the UE; identifying, at 602 from a second network function of the wireless network based on the registration request, an indication of a cryptographic challenge related to a permanent subscription key of the UE; signing, at 603, the cryptographic challenge with a private key of the UE that is based on the BI of the UE to generate a signed cryptographic challenge; providing, at 604, an indication of the signed cryptographic challenge to a function of the blockchain; identifying, at 605 based on the provision of the indication of the signed cryptographic challenge to the function of the blockchain, an indication of a session key related to the wireless network; and communicating, at 606, with the wireless network based on the session key.

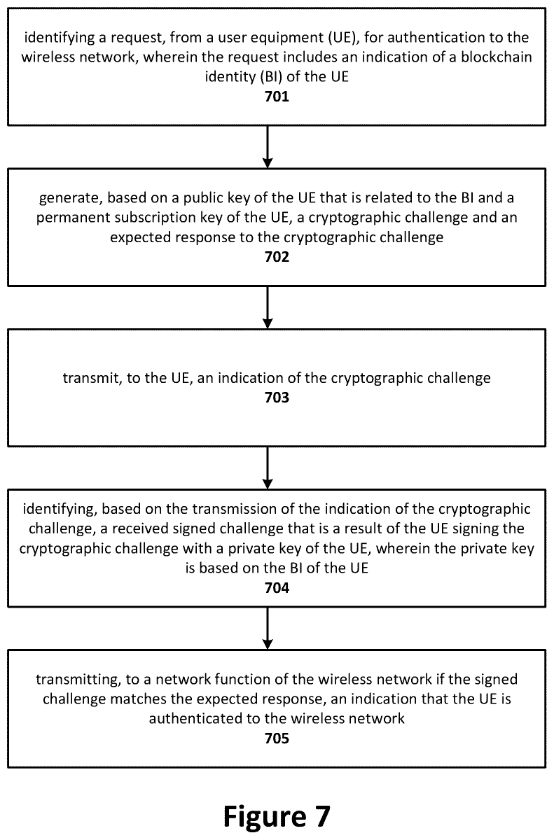

Another such process is depicted in FIG. 7. The process of FIG. 7 may include and/or relate to method to be performed by an authentication function of a wireless network, one or more elements of the authentication function, and/or one or more electronic devices that include and/or implement an authentication function. The process may include identifying, at 701, a request, from a user equipment (UE), for authentication to the wireless network, wherein the request includes an indication of a blockchain identity (BI) of the UE; generating, at 702 based on a public key of the UE that is related to the BI and a permanent subscription key of the UE, a cryptographic challenge and an expected response to the cryptographic challenge; transmitting, at 703 to the UE, an indication of the cryptographic challenge; identifying, at 704 based on the transmission of the indication of the cryptographic challenge, a received signed challenge that is a result of the UE signing the cryptographic challenge with a private key of the UE, wherein the private key is based on the BI of the UE; and transmitting, at 705 to a network function of the wireless network if the signed challenge matches the expected response, an indication that the UE is authenticated to the wireless network.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### 2. Example Implementations

Additional examples of the presently described methods, devices, systems, and networks discussed herein include the following, non-limiting implementations. Each of the following non-limiting examples may stand on its own or may be combined in any permutation or combination with any one or more of the other examples provided below or throughout the present disclosure.

Example 1 includes a blockchain authentication method for authentication in a 5G network, the method comprising: initializing a user equipment (UE) on a blockchain by creating a unique blockchain identity (BI) and storing a cryptographic public key (PK_UE) associated with the UE on the blockchain; and receiving an attestation of an authenticity of the PK_UE from a Trusted Attestation Entity (TA) through digital signature verification.

Example 2 includes the method of example 1 and/or some other example(s) herein, wherein the UE is to initiate a service request to a Security Anchor Function (SEAF) using the BI.

Example 3 includes the method of example 2 and/or some other example(s) herein, wherein the SEAF is to forward the service request and the BI to an Authentication Server Function (AUSF) for authentication.

Example 4 includes the method of example 3 and/or some other example(s) herein, wherein the method includes: receiving the BI from the AUSF; and sending the PK_UE and the attestation to the AUSF based on the received BI.

Example 5 includes the method of example 4 and/or some other example(s) herein, wherein the AUSF is to fetch a subscription permanent Key (K) associated with the UE from a UDM.

Example 6 includes the method of example 5 and/or some other example(s) herein, wherein the AUSF is to generate a cryptographic challenge (RAND) and an expected response (RES*) based on the K; and is to send the RAND and the RES* to the UE for validation.

Example 7 includes the method of example 6 and/or some other example(s) herein, wherein the UE is to sign the RAND using a private key (SK_UE) to generate signed data (SIGNED_RAND)

Example 8 includes the method of example 7 and/or some other example(s) herein, wherein the method includes: verifying the SIGNED_RAND against the PK_UE stored on the blockchain.

Example 9 includes the method of examples 7-8 and/or some other example(s) herein, wherein the AUSF is to verify the SIGNED_RAND against the PK_UE stored on the blockchain.

Example 10 includes the method of examples 8-9 and/or some other example(s) herein, wherein the SEAF is to confirm authentication success if the verification of the SIGNED_RAND is successful and a derived response matches the RES*.

Example 11 includes the method of example 10 and/or some other example(s) herein, wherein the SEAF and the UE derive a session key based on the authentication success, the derived response and/or the RES*, and additional keying materials.

Example 12 includes a method for blockchain-integrated authentication in a 5G communication network, the method comprising: initializing a UE on a blockchain by creating a unique Blockchain Identity (BI) and storing a cryptographic public key (PK_UE) associated with the UE on the blockchain; attesting the authenticity of the UE's public key (PK_UE) by a Trusted Attestation Entity (TA) through digital signature verification; initiating a service request by the UE to a SEAF using the Blockchain Identity (BI) as identification; forwarding the service request and the Blockchain Identity (BI) from the SEAF to an AUSF for authentication; retrieving the authenticated public key (PK_UE) and its associated digital attestation from the blockchain using the Blockchain Identity (BI); fetching a Subscription Permanent Key (K) associated with the UE from a UDM system; generating a cryptographic challenge (RAND) and an expected response (RES*) based on the Subscription Permanent Key (K) by the AUSF and sending them to the UE for validation; generating a signed data (SIGNED_RAND) by the UE using its private key (SK_UE) to sign the received challenge (RAND); verifying the signed data (SIGNED_RAND) against the authenticated public key (PK_UE) stored on the blockchain; confirming the authentication success to the SEAF if the verification of the signed data (SIGNED_RAND) is successful and the derived response (RES*) matches the expected response; and deriving a session key between the SEAF and the UE based on the authentication success, the derived response (RES*), and additional keying materials.

Example 13 includes a blockchain-integrated authentication system for a 5G communication network, comprising: a UE configured to initialize its presence on a blockchain by creating a unique Blockchain Identity (BI) and storing a cryptographic public key (PK_UE) associated with the UE on the blockchain; a Trusted Attestation Entity (TA) configured to digitally attest the authenticity of the UE's public key (PK_UE) through digital signature verification; an SEAF configured to receive a service request from the UE using the Blockchain Identity (BI) as identification and forward the request to an AUSF for authentication; the AUSF configured to retrieve the authenticated public key (PK_UE) and its associated digital attestation from the blockchain using the Blockchain Identity (BI) and fetch a Subscription Permanent Key (K) associated with the UE from a UDM system, wherein the AUSF is configured to generate a cryptographic challenge (RAND) and an expected response (RES*) based on the Subscription Permanent Key (K) and send them to the UE for validation, the UE is configured to generate a signed data (SIGNED_RAND) using its private key (SK_UE) to sign the received challenge (RAND) and verify the signed data (SIGNED_RAND) against the authenticated public key (PK_UE) stored on the blockchain; the AUSF is configured to confirm the authentication success to the SEAF if the verification of the signed data (SIGNED_RAND) is successful and the derived response (RES*) matches the expected response, and wherein the SEAF and the UE cooperatively configured to derive a session key based on the authentication success, the derived response (RES*), and additional keying materials for secure and encrypted communication.

Example 14 may include a method to be performed by a user equipment (UE), one or more elements of a UE, and/or one or more electronic devices that include and/or implement a UE, wherein the method comprises: transmitting, to a first network function of a wireless network, a registration request, wherein the registration request includes an indication of a blockchain identity (BI) of the UE; identifying, from a second network function of the wireless network based on the registration request, an indication of a cryptographic challenge related to a permanent subscription key of the UE; signing the cryptographic challenge with a private key of the UE that is based on the BI of the UE to generate a signed cryptographic challenge; providing an indication of the signed cryptographic challenge to a function of the blockchain; identifying, based on the provision of the indication of the signed cryptographic challenge to the function of the blockchain, an indication of a session key related to the wireless network; and communicating with the wireless network based on the session key.

Example 15 may include the subject matter of example 14, and/or some other example herein, wherein the second network function is an authentication server function (AUSF) of the wireless network.

Example 16 may include the subject matter of any one or more of examples 14-15, and/or some other example herein, wherein the method further comprises generating, by the UE, the public key based on the BI of the UE.

Example 17 may include the subject matter of example 16, and/or some other example herein, wherein the method further comprises transmitting an indication of the public key of the UE to the function of the blockchain.

Example 18 may include the subject matter of any one or more of examples 14-17, and/or some other example herein, wherein the method further comprises identifying, by the UE, an indication of an expected response to the cryptographic challenge.

Example 19 may include the subject matter of example 18, and/or some other example herein, wherein the session key is based on the expected response to the cryptographic challenge.

Example 20 may include the subject matter of any one or more of examples 14-19, and/or some other example herein, wherein the method further comprises generating, by the UE, the BI of the UE.

Example 21 may include a method to be performed by an authentication function of a wireless network, one or more elements of the authentication function, and/or one or more electronic devices that include and/or implement an authentication function, wherein the method comprises: identifying a request, from a user equipment (UE), for authentication to the wireless network, wherein the request includes an indication of a blockchain identity (BI) of the UE; generating, based on a public key of the UE that is related to the BI and a permanent subscription key of the UE, a cryptographic challenge and an expected response to the cryptographic challenge; transmitting, to the UE, an indication of the cryptographic challenge; identifying, based on the transmission of the indication of the cryptographic challenge, an indication of a signed challenge that is a result of the UE signing the cryptographic challenge with a private key of the UE, wherein the private key is based on the BI of the UE; and transmitting, to a network function of the wireless network if the signed challenge matches the expected response, an indication that the UE is authenticated to the wireless network.

Example 22 may include the subject matter of example 21, and/or some other example herein, wherein the method further comprises transmitting, to the UE, an indication of the expected result.

Example 23 may include the subject matter of any one or more of examples 21-22, and/or some other example herein, wherein the method further comprises transmitting the indication that the UE is authenticated based on receipt, from an entity of the blockchain, of an indication that the signed challenge is valid.

Example 24 may include the subject matter of any one or more of examples 21-23, and/or some other example herein, wherein the network function is a security anchor function (SEAF) of the wireless network.

Example 25 may include the subject matter of any one or more of examples 21-24, and/or some other example herein, further comprising retrieving an indication of the permanent subscription key from a unified data management (UDM) function of the wireless network.

Example 26 may include the subject matter of any one or more of examples 21-25, and/or some other example herein, further comprising retrieving an indication of the public key of the UE from an entity of the blockchain.

Example Z01 includes one or more computer readable media comprising instructions, wherein execution of the instructions by processor circuitry is to cause the processor circuitry to perform the method of any one of examples 1-26. Example Z02 includes a computer program comprising the instructions of example Z01. Example Z03 includes an Application Programming Interface defining functions, methods, variables, data structures, and/or protocols for the computer program of example Z02. Example Z04 includes an API or specification defining functions, methods, variables, data structures, protocols, and the like, defining or involving use of any of examples 1-26 or portions thereof, or otherwise related to any of examples 1-26 or portions thereof. Example Z05 includes an apparatus comprising circuitry loaded with the instructions of example Z01. Example Z06 includes an apparatus comprising circuitry operable to run the instructions of example Z01. Example Z07 includes an integrated circuit comprising one or more of the processor circuitry of example Z01 and the one or more computer readable media of example Z01. Example Z08 includes a computing system comprising the one or more computer readable media and the processor circuitry of example Z01. Example Z09 includes an apparatus comprising means for executing the instructions of example Z01. Example Z10 includes a signal generated as a result of executing the instructions of example Z01. Example Z11 includes a data unit generated as a result of executing the instructions of example Z01. Example Z12 includes the data unit of example Z11 and/or some other example(s) herein, wherein the data unit is a datagram, network packet, data frame, data segment, a Protocol Data Unit (PDU), a Service Data Unit (SDU), a message, or a database object. Example Z13 includes a signal encoded with the data unit of examples Z11 and/or Z12. Example Z14 includes an electromagnetic signal carrying the instructions of example Z01. Example Z15 includes an apparatus comprising means for performing the method of any one of examples 1-26 and/or some other example(s) herein. Example Z16 includes a service related to any of examples 1-26, portions thereof, and/or some other example(s) herein. Example Z17 includes a compute node executing the service of example Z16 as part of one or more applications instantiated on virtualization infrastructure.

### 3. Terminology

For the purposes of the present document, the following terms and definitions are applicable to the examples and embodiments discussed herein. Additionally, the definitions provided in 3GPP TS 33.501 may also be applicable to the various aspects discussed herein. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof. The phrase “A and/or B” means (A), (B), or (A and B). For the purposes of the present disclosure, the phrase “A, B, and/or C” means (A), (B), (C), (A and B), (A and C), (B and C), or (A, B and C). The phrase “X(s)” means one or more X or a set of X. The description may use the phrases “in an embodiment,” “In some embodiments,” “in one implementation,” “In some implementations,” “in some examples”, and the like, each of which may refer to one or more of the same or different embodiments, implementations, and/or examples. Furthermore, the terms “comprising,” “including,” “having,” and the like, as used with respect to the present disclosure, are synonymous.

Although terms and examples herein are provided with use of specific cellular/mobile network terminology, including with the use of 4G/5G 3GPP network components (or expected terahertz-based sixth generation (6G)/6G+technologies), it will be understood these examples may be applied to many other deployments of wide area and local wireless networks, as well as the integration of wired networks (including optical networks and associated fibers, transceivers, and/or the like). Furthermore, various standards (e.g., 3GPP, ETSI, and/or the like) may define various message formats, PDUs, containers, frames, and/or the like, as comprising a sequence of optional or mandatory data elements (DEs), data frames (DFs), information elements (IEs), and/or the like. However, it should be understood that the requirements of any particular standard should not limit the examples discussed herein, and as such, any combination of containers, frames, DFs, DEs, IEs, values, actions, and/or features are possible in various examples, including any combination of containers, DFs, DEs, values, actions, and/or features that are strictly required to be followed in order to conform to such standards or any combination of containers, frames, DFs, DEs, IEs, values, actions, and/or features strongly recommended and/or used with or in the presence/absence of optional elements.

Aspects of the subject matter may be referred to herein, individually and/or collectively, merely for convenience and without intending to voluntarily limit the scope of this application to any single aspect or concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects and other aspects not specifically described herein will be apparent to those of skill in the art upon reviewing the above description.

1. An apparatus for use in a user equipment (UE), wherein the apparatus comprises:
memory to store information related to a blockchain identity (BI) of the UE; and
one or more processors configured to:
encode, for transmission to a first network function of a wireless network, a registration request, wherein the registration request includes an indication of a blockchain identity (BI) of the UE;
identify, from a second network function of the wireless network based on the registration request, an indication of a cryptographic challenge related to a permanent subscription key of the UE;
sign the cryptographic challenge with a private key of the UE that is based on the BI of the UE to generate a signed cryptographic challenge;
encode, for transmission to a function of the blockchain, an indication of the signed cryptographic challenge;
identify, based on the provision of the indication of the signed cryptographic challenge to the function of the blockchain, an indication of a session key related to the wireless network; and
encode, based on the session key and for transmission to the wireless network, one or more communications.

2. The apparatus of claim 1, wherein the second network function is an authentication server function (AUSF) of the wireless network.

3. The apparatus of claim 1, wherein the one or more processors are further configured to generate the public key based on the BI of the UE.

4. The apparatus of claim 3, wherein the one or more processors are further configured to encode, for transmission to the function of the blockchain, an indication of the public key of the UE.

5. The apparatus of claim 1, wherein the one or more processors are further configured to identify an indication of an expected response to the cryptographic challenge.

6. The apparatus of claim 5, wherein the session key is based on the expected response to the cryptographic challenge.

7. The apparatus of claim 1, wherein the one or more processors are further configured to generate the BI of the UE.

8. One or more non-transitory computer-readable media (NTCRM) comprising instructions that, upon execution of the instructions by one or more processors of an electronic device, are configured to cause an authentication function of a wireless network to:
identify a request, from a user equipment (UE), for authentication to the wireless network, wherein the request includes an indication of a blockchain identity (BI) of the UE;
generate, based on a public key of the UE that is related to the BI and a permanent subscription key of the UE, a cryptographic challenge and an expected response to the cryptographic challenge;
transmit, to the UE, an indication of the cryptographic challenge;
identify, based on the transmission of the indication of the cryptographic challenge, a received signed challenge that is a result of the UE signing the cryptographic challenge with a private key of the UE, wherein the private key is based on the BI of the UE; and
transmit, to a network function of the wireless network if the signed challenge matches the expected response, an indication that the UE is authenticated to the wireless network.

9. The one or more non-transitory computer-readable media of claim 8, wherein the instructions are further to cause the authentication function to provide, to the UE, an indication of the expected result.

10. The one or more non-transitory computer-readable media of claim 8, wherein the instructions are further to cause the authentication function to provide the indication that the UE is authenticated based on receipt, from an entity of the blockchain, of an indication that the signed challenge is valid.

11. The one or more non-transitory computer-readable media of claim 8, wherein the network function is a security anchor function (SEAF) of the wireless network.

12. The one or more non-transitory computer-readable media of claim 8, wherein the instructions are further to cause thee authentication function to retrieve an indication of the permanent subscription key from a unified data management (UDM) function of the wireless network.

13. The one or more non-transitory computer-readable media of claim 8, wherein the instructions are further to cause the authentication function to retrieve an indication of the public key of the UE from an entity of the blockchain.

14. One or more non-transitory computer-readable media comprising instructions that, upon execution of the instructions by one or more processors of an electronic device, are to cause a user equipment (UE) to:
transmit, to a first network function of a wireless network, a registration request, wherein the registration request includes an indication of a blockchain identity (BI) of the UE;
identify, from a second network function of the wireless network based on the registration request, an indication of a cryptographic challenge related to a permanent subscription key of the UE;
sign the cryptographic challenge with a private key of the UE that is based on the BI of the UE to generate a signed cryptographic challenge;
provide an indication of the signed cryptographic challenge to a function of the blockchain;
identify, based on the provision of the indication of the signed cryptographic challenge to the function of the blockchain, an indication of a session key related to the wireless network; and
communicate with the wireless network based on the session key.

15. The one or more non-transitory computer-readable media of claim 14, wherein the second network function is an authentication server function (AUSF) of the wireless network.

16. The one or more non-transitory computer-readable media of claim 14, wherein the instructions are further to cause the UE to generate the public key based on the BI of the UE.

17. The one or more non-transitory computer-readable media of claim 16, wherein the instructions are further to cause the UE to transmit an indication of the public key of the UE to the function of the blockchain.

18. The one or more non-transitory computer-readable media of claim 14, wherein the instructions are further to cause the UE to identify an indication of an expected response to the cryptographic challenge.

19. The one or more non-transitory computer-readable media of claim 18, wherein the session key is based on the expected response to the cryptographic challenge.

20. The one or more non-transitory computer-readable media of claim 14, wherein the instructions are further to cause the UE to generate the BI of the UE.
